(19) United States
(12) Patent Application Publication
(10) Pub. No.: US 2017/0023406 A1
(43) Pub. Date: Jan. 26, 2017

(54) PASSIVE DETECTORS FOR IMAGING SYSTEMS

(71) Applicant: DIGITAL DIRECT IR, INC., FRESH MEADOWS, NY (US)

(72) Inventors: Peter N. Kaufman, Fresh Meadows, NY (US); Lynn F. Fuller, Rochester, NY (US)

(21) Appl. No.: 15/131,048

(22) Filed: Apr. 18, 2016

Related U.S. Application Data
(63) Continuation-in-part of application No. 14/677,954, filed on Apr. 2, 2015.
Application No. 14/677,954 is a continuation of application No. 13/588,441, filed on Aug. 17, 2012, now Pat. No. 9,012,845.
(60) Provisional application No. 61/524,669, filed on Aug. 17, 2011.
(60) Provisional application No. 62/148,829, filed on Apr. 17, 2015.

(51) Int. Cl. G01J 1/44; G01J 1/02

(52) U.S. Cl. CPC G01J 1/44; G01J 1/0204

(57) ABSTRACT

Passive detector structures for imaging systems are provided, which are based on a coefficient of thermal expansion (CTE) framework. For example, an imaging device includes a substrate, and a photon detector disposed over a surface of the substrate. The photon detector comprises a stack of thin film layers including a resonator member and an unpowered detector member. The resonator member generates an output signal having a frequency or period of oscillation. The unpowered detector member has a CTE, which causes the unpowered detector member to expand or contract due to thermal heating resulting from photon exposure, and apply a mechanical force to the resonator member. The mechanical force causes a change in the frequency or period of oscillation of the output signal generated by the resonator member, wherein the change in the frequency or period of oscillation is utilized to determine an amount of photon exposure of the photon detector.

### CROSS-REFERENCE TO RELATED APPLICATIONS

This application is a Continuation in Part of U.S. patent application Ser. No. 14/677,954, filed on Apr. 2, 2015, which is a Continuation of U.S. patent application Ser. No. 13/588,441, filed on Aug. 17, 2012, now U.S. Pat. No. 9,012,845, which claims priority to U.S. Provisional Patent Application Ser. No. 61/524,669, filed on Aug. 17, 2011, the disclosures of which are incorporated herein by reference. This application claims priority to U.S. Provisional Patent Application Ser. No. 62/148,829, filed on Apr. 17, 2015, the disclosure of which is incorporated herein by reference.

### TECHNICAL FIELD

The field generally relates to photon detector structures, photon detector arrays, and imaging systems and methods.

### BACKGROUND

Conventional imager technologies use quantum and analog detectors, which are complicated to design, build and contain inherent fabrication and performance problems that are difficult and expensive to resolve. These detectors can only detect a small segment of the IR spectrum, either 4 μm or 10 μm (mid or far IR respectively), which is dependent on the detector material selected, the detector design and size. Some disadvantages and limitations of current IR technology are as follows.

The quantum semiconductor technologies have highly complex intricate structures. For example, each pixel has a multitude of nano-sized structures, which makes them difficult to fabricate, and expensive to produce. Moreover, multiple stages contribute noise which limits performance, and improving performance is complex and redesigns are expensive. The complexity requires high-end fabrication facilities and foundries. All these factors contribute to the high cost of such imagers. Furthermore, conventional imager designs are limited to one narrow segment of the IR spectrum, either 4μ or 10μ individually. The analog signals generated by conventional imager designs must be converted to a digital signal (via A/D conversion) before the signal is made into a video image. The instability and noise of analog systems is a significant problem and limits imager performance.

### SUMMARY

Embodiments of the invention generally include imaging devices and methods, and in particular, passive detector structures which are based on a coefficient of thermal expansion (CTE) framework.

For example, one embodiment of the invention includes an imagine device. The imaging device includes a substrate, and a photon detector disposed over a surface of the substrate. The photon detector comprises a stack of thin film layers, wherein the thin film layers include a resonator member, an unpowered detector member, and a thermal insulating member. The resonator member is configured to generate an output signal having a frequency or period of oscillation. The unpowered detector member is configured for photon exposure, and comprises a material having a thermal coefficient of expansion that causes the unpowered detector member to distort due to the photon exposure. The unpowered detector member is further configured to apply a mechanical force to the resonator member due to the distortion of the unpowered detector member, and cause a change in the frequency or period of oscillation of the output signal generated by the resonator member due to the mechanical force applied to the resonator member. The thermal insulating member is configured to thermally insulate the resonator member from the unpowered detector member. The imaging device further includes digital circuitry configured to (i) determine the frequency or period of oscillation of the output signal generated by the resonator member as a result of the mechanical force applied to the resonator member by the unpowered detector member, and to (ii) determine an amount of the photon exposure based on the determined frequency or period of oscillation of the output signal generated by the resonator member.

Another embodiment of the invention includes a method for detecting photonic energy, wherein the method comprises:

exposing a photon detector to incident photons, wherein the photon detector comprises a stack of thin film layers, wherein the thin film layers include an unpowered detector member, a resonator member, and a thermal insulating member configured to thermally insulate the resonator member from the unpowered detector member, wherein the resonator member is configured to generate an output signal having a frequency or period of oscillation;

distorting the unpowered detector member due to the photon exposure, wherein the unpowered detector member comprises a material having a thermal coefficient of expansion that causes the unpowered detector member to distort due to the photon exposure;

applying a mechanical force to the resonator member due to the distorting of the unpowered detector member;

determining a frequency or period of oscillation of the output signal generated by the resonator member as a result of the mechanical force applied to the resonator member by the unpowered detector member, and

determining an amount of the photon exposure of the photon detector based on the determined frequency or period of oscillation of the output signal generated by the resonator member.

Other embodiments of the invention will be described in following detailed description of illustrative embodiments thereof, which is to be read in conjunction with the accompanying drawings.

### BRIEF DESCRIPTION OF THE DRAWINGS

FIG. 1 is a perspective view of a photon detector device according to an exemplary embodiment of the invention, which is based on a coefficient of thermal expansion (CTE) framework.

FIG. 2 is an exploded view of a stacked photon detector structure according to an embodiment of the invention.

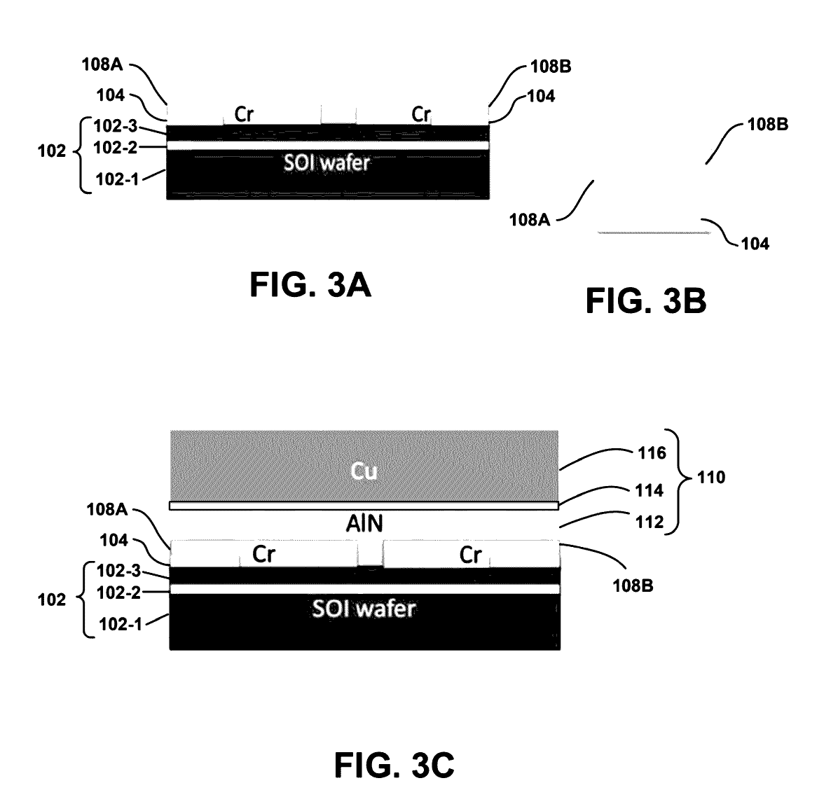

FIGS. 3A, 3B, 3C, 3D, 3E schematically illustrate a method for fabricating the photon detector of FIG. 1, according to an embodiment of the invention.

FIG. 4 is a block diagram of an imager system based on passive detectors, according to an exemplary embodiment of the invention.

FIG. 5 is a block diagram that illustrates another exemplary embodiment of a pixel unit and pixel circuitry, which can be implemented in the imager system of FIG. 4.

### DETAILED DESCRIPTION

Embodiments of the invention will now be described in further detail below with regard passive detector structures for imaging systems, which are based on a coefficient of thermal expansion (CTE) framework. Exemplary embodiments of CTE-based passive detector structures as described herein are extensions of the CTE-based passive detector frameworks disclosed in U.S. Pat. No. 9,012,845 (and its Continuation U.S. patent application Ser. No. 14/677,954). These patents describe a new paradigm for detecting incident IR energy, for example, using passive detector structures which provide direct-to-digital measurement data output for detecting incident IR radiation with no analog front end (no A/D conversion) or quantum semiconductors, thereby providing a low noise, low power, low cost and ease of manufacture detector design, as compared to conventional CMOS or CCD detector devices. Passive detector frameworks with direct-to-digital measurement data output as described herein do not use quantum photonic or electron conversion techniques, and have none of the technological, manufacturing or noise problems associated with conventional imager technologies.

For example, a thermal infrared detector framework as described in U.S. Pat. No. 9,012,845 comprises a resonator member formed of a piezoelectric material (e.g., lead zirconate titanate (also referred to as PZT)) that is configured to resonate in response to a drive voltage and generate an output signal having a frequency Or period of oscillation. The thermal IR detector further comprises an electrically unpowered detector member which is configured for exposure to incident thermal infrared radiation. The electrically unpowered detector member comprises a material having a thermal coefficient of expansion (CTE) which causes the electrically unpowered detector member to distort (e.g., expand Or contract) in response to thermal heating resulting from absorption of incident thermal infrared radiation. The electrically unpowered detector member applies a mechanical force to the piezoelectric resonator member due to the distortion of the electrically unpowered detector member, which causes a change in a frequency or period of oscillation of the output signal generated by the piezoelectric resonator member. The thermal infrared detector further includes a thermal insulating member configured to thermally insulate the piezoelectric resonator member from the electrically unpowered detector member.

It is to be understood that the various layers, structures, and regions shown in the accompanying drawings are schematic illustrations that are not drawn to scale. In addition, for ease of explanation, one or more layers, structures, and regions of a type commonly used to form imaging devices Or structures may not be explicitly shown in a given drawing. This does not imply that any layers, structures, and regions not explicitly shown are omitted from the actual imaging devices and structures. Furthermore, it is to be understood that the embodiments discussed herein are not limited to the particular materials, features, and/or processing steps as described herein.

Moreover, the same or similar reference numbers are used throughout the drawings to denote the same or similar features, elements, or structures, and thus, a detailed explanation of the same or similar features, elements, or structures will not be repeated for each of the drawings. It is to be understood that the term “about” as used herein with regard to thicknesses, widths, percentages, ranges, etc., is meant to denote being close or approximate to, but not exactly. For example, the term “about” as used herein implies that a small margin of error is present, such as 1% or less than the stated amount.

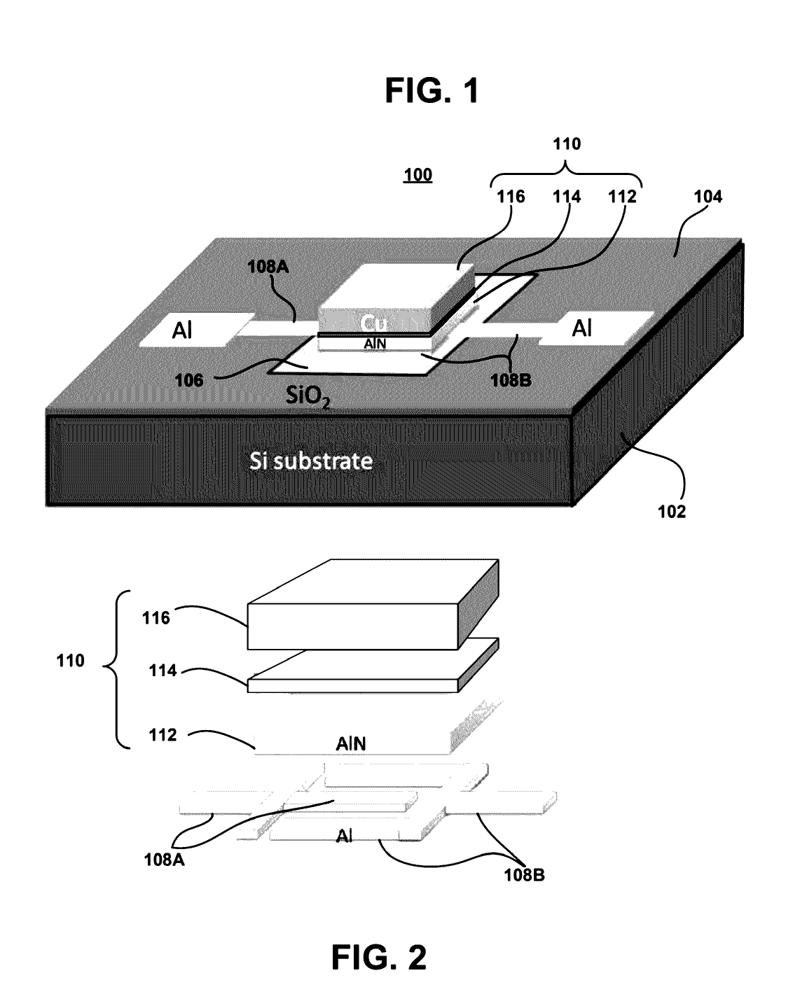

FIG. 1 is a perspective view of a photon detector device 100 according to an exemplary embodiment of the invention, which is based on a coefficient of thermal expansion (CTE) framework. In one embodiment of the invention, the photo detector device 100 comprises a thermal imaging sensor which is based on a resonant MEMS structure. The photon detector device 100 comprises a substrate 102, an insulating layer 104, an open cavity 106, first and second electrodes 108A and 108B, and a detector structure 110. The detector structure 110 comprises a resonator member 112, a thermal insulating member 114, and an unpowered detector member. This embodiment provides an MEMS structure that integrates a thermal infrared absorber material with a resonant film structure to provide a sensor that is sensitive to Infrared radiation.

The resonator member 112 is configured to generate an output signal having a frequency or period of oscillation. The unpowered detector member 116 is configured for photon exposure, wherein the unpowered detector member 116 comprises a material having a thermal coefficient of expansion that causes the unpowered detector member 116 to distort (e.g., expand) due to photon exposure (e.g., expand due to heating of the detector member 116 due to absorption of photons). The unpowered detector member 116 is configured to apply a mechanical force to the resonator member due 112 as a result of the distortion of the unpowered detector member 116, and cause a change in the frequency or period of oscillation of the output signal generated by the resonator member 112 due to the mechanical force applied to the resonator member 112. The thermal insulating member 114 is configured to thermally insulate the resonator member 112 from the unpowered detector member 116.

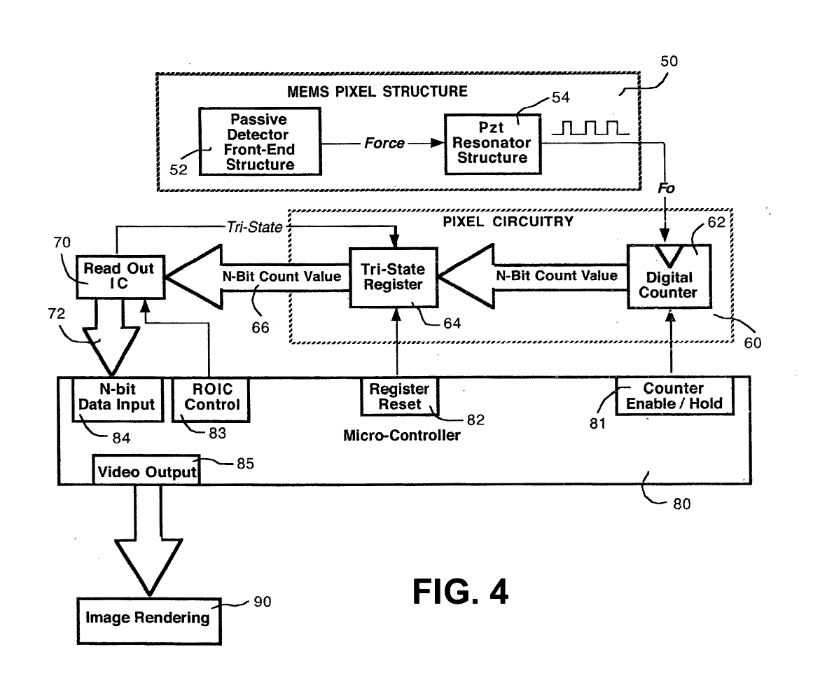

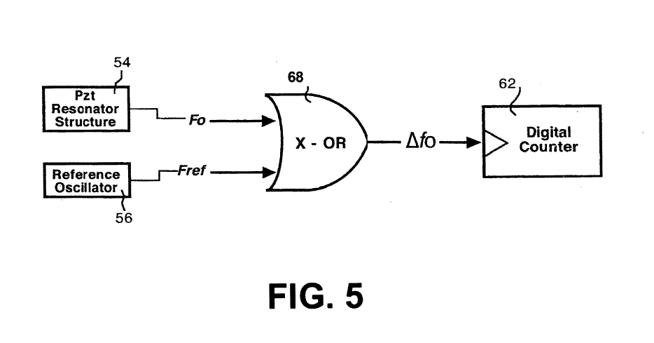

Although not specifically shown in FIG. 1, the substrate 102 comprises an integrated circuit comprising digital circuitry configured to (i) determine the frequency or period of oscillation of the output signal generated by the resonator member 112 as a result of the mechanical force applied to the resonator member 112 by the unpowered detector member 116, and to (ii) determine an amount of said photon exposure based on the determined frequency or period of oscillation of the output signal generated by the resonator member 112. The detector structure 110 is connected to the digital circuitry via the first and second electrodes 108A and 108B, and other interconnect structures and wiring (e.g., BEOL wiring) as may be needed for a given layout. An exemplary embodiment of digital circuity which is configured to determine the frequency or period of oscillation of the output signal determine an amount of said photon exposure based on the determined frequency or period of oscillation of the output signal generated by the resonator member 112, and to determine an amount of photon exposure based on the determined frequency or period of oscillation of the output signal, will be described in further detail below with reference to FIGS. 4 and 5, for example.

In one embodiment of the invention, the unpowered detector member 116 is formed a material (or multiple materials) which can absorb photons (e.g. thermal IR radiation) and which has a suitable thermal coefficient of expansion characteristic. For example, in one embodiment of the invention, the unpowered detector member 116 is formed of copper, or other similar materials.

Further, in one embodiment of the invention, the resonator member 112 is formed of a piezoelectric material that is configured to “molecularly resonate” in response to a drive voltage and generate an output signal having a frequency or period of oscillation. In other words, when a voltage (e.g., DC voltage) is applied across the piezoelectric material, the molecules or atoms of the piezoelectric material collectively move back and forth in first and second opposing directions (causing stretching and compressing of the piezoelectric material). The movement of the molecules or atoms of the piezoelectric material causes the piezoelectric material to generate a voltage differential across the piezoelectric material, and this voltage differential varies with the back and forth movement of the molecules/atoms, which results in the resonator member 112 generating an output signal having a quiescent frequency or period of oscillation. The quiescent frequency or period of oscillation of the signal output from the resonator member 112 will change in response to mechanical force exerted on the resonator member by expansion and contraction of the unpowered detector member 116.

In one embodiment of the invention, the resonator member 112 is formed of AlN (aluminum nitride), or other suitable piezoelectric materials. Moreover, in one embodiment of the invention, the thermal insulating member 114 is formed of graphite, or any other similar or suitable material that can provide thermal isolation between the unpowered detector member 116 and the resonator member 112.

In one embodiment of the invention, the first and second electrodes 108A and 108B are formed of aluminum. The resonator member 112 is formed on the end portions of the first and second electrodes 108A and 108B, which form an interdigitated structure. The resonator member 112 is connected to the first and second electrodes 108A and 108B, such that the detector structure 110 is suspended above the cavity 106 formed in the surface of the substrate 102. The first and second electrodes 108A and 108B apply a drive voltage to the resonator member 112. The first and second electrodes 108A and 108B serve as tethers to hold the stacked detector structure 100 in suspended position above the cavity 106.

In one embodiment of the invention, the resonant frequency of the device will depend on the dimensions and stress characteristics of the films 112, 114, and 116 that form the detector structure 110. As the unpowered detector member 116 absorbs IR radiation, it will expand and change its dimensions and apply interfacial stress forces within the detector structure 110 which causes a change in the resonant frequency of the detector structure 110.

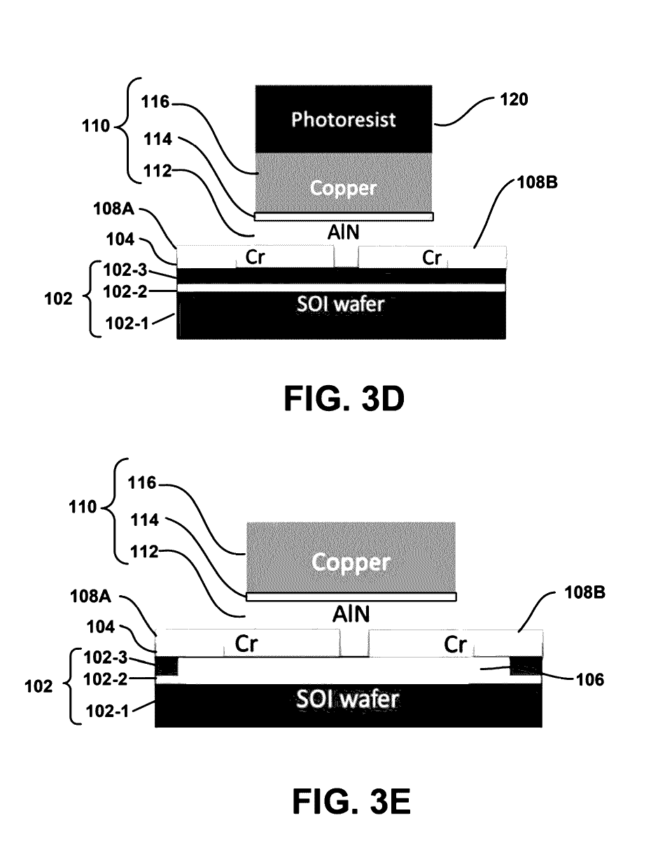

FIGS. 3A, 3B, 3C, 3D, and 3E schematically illustrate a method for fabricating the detector device 100 shown in FIG. 1. Referring to FIG. 3A, the process begins with depositing and patterning a layer of insulating material on a surface of the semiconductor substrate 102 to form the insulating layer 104, followed by depositing and patterning a layer of conductive material to form the electrodes 108A and 108B. In one embodiment of the invention, the semiconductor substrate 102 comprises a SOI (silicon on insulator) substrate comprising a bulk silicon layer 102-1, a BOX (buried oxide) layer 102-2, and a top silicon layer 102-3 formed on the BOX layer 102-2. In one embodiment, the top silicon layer 102-3 has a thickness of about 5-10 μm, and the BOX layer 102-2 has a thickness above about 1-2 μm.

The insulating layer 104 serves to isolate the first and second electrodes 108A and 108B from the substrate 102. In one embodiment of the invention, the insulating layer 104 is formed of silicon dioxide, for example. Moreover, insulating layer 104 is etched to form an etched region that defines a perimeter of the cavity 106, which is formed below the interdigitated end portions of the first and second electrodes 108A and 108B in later processing steps. The insulating layer 104 serves as an etch mask in the process of forming the cavity 106 and releasing the detector structure 110 from the substrate 102.

After patterning the layer of insulating material 104, a metal deposition process is performed to deposit a metallic material (e.g., Aluminum) which is used to form the first and second electrodes 108A and 108B. In one embodiment of the invention, the metallic material that is used for the first and second electrodes 108A and 108B is resistant to the etching material (e.g., XeF2 etch) that is subsequently used to release the detector structure 110. Suitable materials include, but are not limited to, aluminum or chrome. The layer of metallic material is patterned using a suitable etch mask and etch process to form the first and second electrodes 108A and 108B. The initial films (insulating material 104 and electrode material) will be thin in comparison to the materials forming the stacked detector structure 110 such that their stress contribution to the overall structure is expected to be minimal.

FIG. 3A is a schematic cross-sectional view of the resulting structure after depositing and patterning the insulating and conductive material layers to form the insulating layer 104 and the first and second electrodes 108A and 108B on the substrate 102. FIG. 3B is a schematic top plan view of the structure of FIG. 3A showing a geometric configuration and interdigitated layout of the first and second electrodes 108A and 108B, according to an embodiment of the invention.

Next, starting with the structure shown in FIG. 3A, a layer of piezoelectric material 112, a layer of thermal insulating material 114, and a layer of photon absorbing material 116 are sequentially deposited to form the structure shown in FIG. 3C. In one embodiment of the invention, the layers 112, 114 and 116 are deposited using PVD (physical vapor deposition) and/or other suitable deposition techniques. For example, when the piezoelectric film 112 is formed of AlN, the piezoelectric AlN film can be deposited by reactive sputtering of aluminum in nitrogen ambient. The thickness the different layers 112, 114 and 116 can be varied to obtain different response characteristics of the stacked detector structure 110.

As shown in FIG. 3C, the piezoelectric material 112 is disposed in the spaces between the interdigitated ends of the first and second electrodes 108A and 108B. This enables the first and second electrode 108A and 108B to be fixedly connected to the detector structure 110, and serve as tethers to hold the stacked detector structure 110 in suspended position above the cavity 106.

Next, as shown in FIG. 3D, a layer of photoresist material is deposited and patterned to form a photoresist mask 120, which is used to etch the layers 116, 114 and 112 down the metallization layer 108A and 108B, and form the detector structure 110. FIG. 3D is a schematic cross-sectional view of the resulting structure after etching the layers 116, 114 and 112 using the photoresist mask 120. Although one detector structure 110 is shown in, e.g., FIG. 3D, an array of such detector structures 110 can be formed in the process. Depending on the materials used to form the different layers 116, 114, and 112, lift-off techniques may be implemented in instances where no optimum chemistry can be used to selectively etch the films 116, 114, 112 with respect to the patterned metallization layer of the electrodes 108A and 108B.

Referring now to FIG. 3E, a release process is performed to release the detector structure 110 from the substrate 102. For example, an XeF2 etch process can be performed to remove a portion of the underlying silicon layer 102-3 which is exposed via the open region of the insulating layer 104, and the spacing between the interdigitated ends of the electrodes 108A and 108B, for form the open cavity 106. In this process, the etch process is performed selective to the materials forming the different layers 116, 114, 112, 104, and the conductive material of the electrodes 108A and 108B. The thin layer of insulating material 104 (e.g., SiO2) serves as a mask for the XeF2 etch process. The BOX layer 102-2 will reduce the etch time needed to release the detector structure 110 by limiting the amount of silicon to be etched to form the open cavity 106. The photoresist mask 120 is removed following release of the detector structure 110 from the substrate 102.

FIG. 3E is a schematic cross-sectional view of the resulting structure after release of the detector structure 110 and removal of the photoresist mask 120. As shown in FIG. 3E, the detector structure 110 is suspended Over the cavity 106 formed in the surface of the substrate 102 by the end portions of the first and second electrodes 108A and 108B. In this configuration, the detector structure 110 is free to expand or contract freely as result of heating of the unpowered detector member 116 by absorption of infrared radiation.

In another embodiment of the invention, a stacked detector structure (e.g., having the same or similar layers as the stacked detector structure 110) can be suspended above the substrate using first and second electrode “fixed post” structures that are formed on the substrate, similar to the embodiment in FIGS. 6A and 6B of U.S. patent application Ser. No. 14/677,954. In this embodiment, opposing end portions of the stacked detector structure would be connected to the first and second electrodes, with the stacked detector structure (e.g., ribbon structure) suspended above the substrate. Other structural configurations may be implemented to suspend a stacked detector structure above a substrate.

FIG. 4 is a block diagram of an imager system implementing passive detectors, according to an exemplary embodiment of the invention. In general, FIG. 4 shows an imager circuit comprising a pixel structure 50, pixel circuitry 60, a read out integrated circuit 70 (“ROIC”), a controller 80, and an image rendering system 90. The pixel 50 comprises a passive detector front-end structure 52 and a resonator structure 54. The pixel circuitry 60 comprises a digital counter 62 and a tri-state register 64. The controller 80 comprises a counter enable/hold control block 81, a register reset block 82, an ROIC control block 83, a data input control block 84, and a video output control block 85.

In the pixel structure 50 of FIG. 4, the passive detector front-end structure 52 generically represents any one of the passive pixel detector structures discussed herein, including the support structures and detector elements that are designed to be mechanically distorted in response to photon exposure, for example, and apply mechanical stress (force) to the resonator structure 54. The detector front-end structure 54 is electrically passive and has no noise generating electronics.

The resonator structure 54 oscillates at a resonant frequency E, and outputs a square wave signal. The resonator structure 54 is designed to have a reference (or base) resonant frequency (no photon exposure) in a state in which no additional stress, other than the pre-stress amount, is applied to the resonator structure 54 by the detector front-end 52 due to photon exposure. As mechanical stress is applied to the resonator member 54 from the detector front-end 52 due to photon exposure, the oscillating frequency of the resonator member 54 will increase from its reference (base) resonant frequency. In one exemplary embodiment, the digital circuits 60, 70 and 80 collectively operate to determine the output frequency Fₒ of the resonator member 54 due to the force exerted on the resonator member 54 by the expansion and contraction of a passive detector element of the detector front end structure 52, determine an amount of incident photonic energy absorbed by the passive detector element based on the determined resonant frequency Fₒ of the resonator member 54 at a given time, and generate image data based on the determined amount of incident photonic energy at the given time, which is then rendered by the imaging system 90.

In particular, the output signal generated by the resonator member 54 is a digital square wave signal having a frequency Fₒ that varies depending on the stress applied to the resonator member 54 by the passive detector front-end structure 52. The output signal generated by the resonator member 54 is input to a clock input port of the digital counter 62. For each read cycle (or frame) of the imager, the digital counter 62 counts the pulses of the output signal from the resonator member 54 for a given “counting period” (or reference period) of the read cycle. The counting operation of the digital counter 62 is controlled by a CLK enable signal generated by the counter control block 81 of the controller 80. For each read cycle, the count information generated by the counter 62 is output as an n-bit count value to the tri-state register 64.

The ROIC 70 reads out the count value (pixel data) from the pixel circuitry 60 of a given pixel 50 for each read cycle. It is to be understood that for ease of illustration, FIG. 4 shows one pixel unit 50 and one corresponding pixel circuit 60, but an imager can have a plurality of pixel units 50 and corresponding pixel circuits 60 forming a linear pixel array or a 2D focal plane pixel array, for example. In this regard, the ROIC 70 is connected to each pixel circuit 60 over a shared n-bit data bus 66, for controllably transferring the individual pixel data from each pixel counting circuit 60 (which is preferably formed in the active silicon substrate surface under each corresponding pixel structure 50) to the controller 80.

In particular, in response to control signals received from the ROIC control block 83 of the controller 80, the ROIC 70 will output a tri-state control signal to the pixel circuitry 60 of a given pixel 50 to read out the stored count data in the shift-register 64 onto the shared data bus 66. The shift-register 64 of each pixel circuit 60 is individually controlled by the ROIC 70 to obtain the count data for each pixel at a time over the data bus 66. The count data is transferred from the ROIC 70 to the controller 80 over a dedicated data bus 72 connected to the n-bit data input control block 84 of the controller 80. After each read cycle, the tri-state register 64 of each pixel will be reset via a control signal output from the register reset control block 82 of the controller 80.

The controller 80 processes the count data obtained from each pixel in each read cycle or (video frame) to determine the amount of incident photon exposure for each pixel and uses the determined exposure data to create a video image. The video data is output to an image rendering system 90 via the video output block 85 to display an image. In some embodiments of the invention where the counter 62 for a given pixel 50 obtains count data for the given pixel 50 by directly counting the output frequency generated by the resonator member 54, the controller 80 will use the count data to determine a grayscale level for the pixel, which corresponds to the amount of the incident photonic exposure of the pixel. For example, in some embodiments, the grayscale level can be determined using a grayscale algorithm or using a lookup table in which the different grayscale values (over a range from black to white) are correlated with a range of count values for a priori determined increments of changes in the oscillating frequency of the resonator member from the base reference frequency to a maximum oscillating frequency. The maximum oscillating frequency is the highest frequency that can output from the resonator member in response to the maximum amount of stress force that can be created by the given passive detector front-end structure.

In other embodiments of the invention, the pixel structure and pixel circuitry of FIG. 4 can be modified such that the counter will count the frequency of a signal that represents the difference between the base resonant frequency of the resonator member 54 and the actual output frequency generated by the resonator member 54 at a given time in response to stress applied by the passive detector front-end 52. For example, FIG. 5 illustrates another exemplary embodiment of a pixel unit and pixel circuitry that can be implemented in the imager system of FIG. 4. In FIG. 5, the pixel 50 (of FIG. 4) is modified to include a reference oscillator 56 that outputs a reference resonant frequency F_{ref}. The pixel circuitry 60 (of FIG. 4) is modified to include an exclusive-Or gate 68 that receives as input, the output signal of the resonator member 54 (having a variable frequency Fo) and the fixed signal from the reference oscillator 56. The X-Or gate 66 operates to remove the base frequency component of the signal Fo output from the resonator member 54 based on the reference frequency of the reference oscillator 56 and outputs a square wave signal having a frequency equal to the change ΔFₒ in frequency of resonator member 54. The ΔFₒ frequency signal, which is much lower in frequency than the oscillating frequency Fo of the resonator member 54, requires a lower bit number counter 62 to count the ΔFₒ signal, making it simpler to implement. As with the embodiment of FIG. 4, the ΔFₒ signal is counted for a reference period and the count value is used to determine incident photon exposure of the pixel, as discussed above.

Although exemplary embodiments have been described herein with reference to the accompanying drawings for purposes of illustration, it is to be understood that the present invention is not limited to those precise embodiments, and that various other changes and modifications may be affected herein by one skilled in the art without departing from the scope of the invention.

What is claimed is:

1. An imaging device, comprising:
a substrate;
a photon detector disposed over a surface of the substrate, wherein the photon detector comprises a stack of thin film layers, wherein the thin film layers comprise:
a resonator member configured to generate an output signal having a frequency or period of oscillation;
an unpowered detector member, wherein the unpowered detector member is configured for photon exposure, wherein the unpowered detector member comprises a material having a thermal coefficient of expansion that causes the unpowered detector member to distort due to said photon exposure, wherein the unpowered detector member is further configured to apply a mechanical force to the resonator member due to said distortion of the unpowered detector member, and cause a change in the frequency or period of oscillation of the output signal generated by the resonator member due to said mechanical force applied to the resonator member; and
a thermal insulating member configured to thermally insulate the resonator member from the unpowered detector member; and
digital circuitry configured to (i) determine the frequency or period of oscillation of the output signal generated by the resonator member as a result of the mechanical force applied to the resonator member by the unpowered detector member, and to (ii) determine an amount of said photon exposure based on the determined frequency or period of oscillation of the output signal generated by the resonator member.

2. The device of claim 1, wherein the photon detector is configured to detect thermal infrared energy having a wavelength in a range of about 2 micrometers to 25 micrometers.

3. The device of claim 1, wherein the photon detector further comprises a first electrode and a second electrode formed on the substrate, wherein the resonator member is connected to the first and second electrodes and suspended above a surface of the substrate.

4. The device of claim 1, wherein the photon detector further comprises a first electrode and a second electrode, wherein end portions of the first and second electrodes form an interdigitated structure, wherein the resonator member is connected to the interdigitated structure and suspended above a recessed surface of the substrate.

5. The device of claim 4, wherein the first and second electrodes are formed of aluminum.

6. The device of claim 1, wherein the resonator member comprises a layer of piezoelectric material, the thermal insulating member comprises a layer of thermal insulating material, and the unpowered detector member comprises a layer of photon absorbing material, wherein the layer of thermal insulating material is disposed between the layer of piezoelectric material and the layer of photon absorbing material.

7. The device of claim 6, wherein the layer of piezoelectric material comprises aluminum nitride.

8. The device of claim 6, wherein the layer of photon absorbing material comprises copper.

9. A thermal imaging system comprising the device of claim

10. A method, comprising:
exposing a photon detector to incident photons, wherein the photon detector comprises a stack of thin film layers, wherein the thin film layers comprise an unpowered detector member, a resonator member, and a thermal insulating member configured to thermally insulate the resonator member from the unpowered detector member, wherein the resonator member is configured to generate an output signal having a frequency or period of oscillation;
distorting the unpowered detector member due to said photon exposure, wherein the unpowered detector member comprises a material having a thermal coefficient of expansion that causes the unpowered detector member to distort due to said photon exposure;
applying a mechanical force to the resonator member due to the distorting of the unpowered detector member;
determining a frequency or period of oscillation of the output signal generated by the resonator member as a result of the mechanical force applied to the resonator member by the unpowered detector member; and
determining an amount of said photon exposure of said photon detector based on said determined frequency or period of oscillation of the output signal generated by the resonator member.

11. The method of claim 10, further comprising generating image data using the determined frequency.

12. The method of claim 10, wherein determining an amount of said photon exposure comprises:
generating count data by counting a number of digital pulses in the output signal generated by the resonator member for a given counting period; and
determining a level of photon exposure based on said count data.
